(19) United States
(12) Patent Application Publication
(10) Pub. No.: US 2012/0088558 A1
(43) Pub. Date: Apr. 12, 2012

(54) PHONE CASE

(76) Inventor: Tan Qing Song, Shenzhen (CN)

(21) Appl. No.: 12/901,204

(22) Filed: Oct. 8, 2010

(51) Int. Cl. H04M 1/00

(52) U.S. Cl. 455/575.1

(57) ABSTRACT

A case for an electronic device designed to protect the electronic device and extend the battery life of the electronic device is provided. The case has an engagement mechanism, can be engaged to securely fasten the case to the electronic device. The case portion includes a battery to extend the battery life of the electronic device and a connector that allows for the phone to be charge while positioned within the case.

### FIELD OF THE INVENTION

This invention relates to a case for portable electronic devices, and more specifically, to a mobile phone case incorporating an auxiliary battery.

### BACKGROUND OF THE INVENTION

There are a wide variety of portable electronic devices including personal digital assistants (PDAs), computers, smartphones, mobile phones, satellite phones, cellular phones, pagers, music player, MP3 players, media players, digital cameras, video cameras, bar code scanner, global positioning system (GPS), and portable game consoles. Although these devices vary considerably in capabilities and power requirements, typically these devices use a battery as their primary power source.

One of the primary attractions of these devices is their portability. However, because such portable electronic devices are inherently fragile, many different protective cases have been designed to hold these portable electronic devices. These cases can come in many different styles and can incorporate a number of different features. At a minimum these cases generally are designed to the electronic device from physical damage. In addition, these cases may include an auxiliary battery to extend the length of the electronic device's charge.

Despite the wide-variety of styles and features available, most modern cases have several drawbacks. First, the manner in which the case attaches to the electronic device is often cumbersome or lacks adequate security. Of more relevance to those cases that provide an auxiliary source of power, there is typically no mechanism to allow for the simultaneous charging of both the auxiliary battery and the primary battery of the electronic device, nor is there a means for indicating to a use the amount of auxiliary batter power remaining in the case.

Therefore, there is a need for a portable electronic device case that provides additional battery life, in a facile manner.

### BRIEF SUMMARY OF THE INVENTION

The current invention is directed to a case for containing an electronic device, the case comprising an auxiliary battery.

In one embodiment, the case incorporates a lower case portion and an upper case portion, where the lower and upper case portions are rotatably interconnected. In one such embodiment, the rotatable connection is a hinge mechanism.

In another embodiment, the upper and lower portions are also slidingly interconnected, such that when the upper portion is axially aligned with the lower portion, the upper portion may be slid downward toward the bottom of the lower portion. In such an embodiment, the upper and lower portions are preferably lockingly engaged to one another. In such an embodiment the licking interconnection may take the form of a frictional fitting, a compression fitting, a snap, latch or other locking mechanism.

In still another embodiment, the case the compartment for containing the electronic device, is defined by a back surface and is bounded by left, right and lower sidewalls, and a top edge. In such an embodiment, the back side of the electronic device rests against the back surface of the compartment and the lower side of the electronic device rests against the lower sidewall.

In yet another embodiment, the battery is enclosed in the lower case portion. In such an embodiment, the battery is preferably a rechargeable battery.

In still yet another embodiment, the case further includes electronic circuitry, coupled to the battery for controlling the function of the battery.

In still yet another embodiment, the case includes an inner electric connecter positioned to interconnect with an electric connector on the electronic device. In such an embodiment, the inner electric connector is electrically coupled through the electronic circuitry to the battery.

In still yet another embodiment, the case includes an external electric connector. In such an embodiment, the external electric connector is electrically coupled through the electronic circuitry to both the battery and the inner electric connector. In one such embodiment, the external electric connector is a mini-USB connector.

In still yet another embodiment, the upper portion of the case includes left, right and upper sidewall and an open side end, opposite of the upper sidewall. In such an embodiment, the upper sidewall is positioned against a top side edge of the electronic device when the upper case portion is seated against the lower case portion.

In still yet another embodiment, when the upper and lower case portions of the case are merged they form a combined front opening through which a screen of the electronic device is visible.

In still yet another embodiment, the sidewalls of one of either the upper or lower case portions further include at least one opening through which functional portions of the electronic device will be accessible. In such an embodiment, the front opening of the lower portion comprises a U shape, and the front opening of the upper portion comprises an upside-down U shape.

In still yet another embodiment, one of either the lower or upper case portions further comprise at least one user control coupled to the electronic circuitry, and designed to activate at least one function of the case.

In still yet another embodiment, one of either the lower or upper case portions further include at least one indicator coupled to the electronic circuitry. In such an embodiment, the at least one indicator is designed to indicate the status of at least one aspect of the function of one of either the case or the electronic device. In yet another such embodiment, the at least one indicator specifies a level of charge remaining for the battery.

In still yet another embodiment, the case includes an opening against which a camera lens opening of the electronic device will be placed.

In still yet another embodiment, the case includes at least one opening positioned on the lower sidewall, such that when the electronic device is inserted into the compartment the speaker outputs of said electronic device are aligned with said at least one opening in said lower sidewall.

In still yet another embodiment, the case is formed of a rigid plastic material.

In still yet another embodiment, when the upper case portion is seated against the lower case portion, the upper case portion overlaps at least one portion of the lower case portion.

In still yet another embodiment, when connecting a cable to the outer connector of the lower case portion, the cable does not pass through any opening of the case.

In still yet another embodiment, the case further includes an extendable bracket armature attached to the back thereof. In such an embodiment, the bracket armature is designed to support the case in a standing position.

In still yet another embodiment, the electronic device is a smartphone.

### BRIEF DESCRIPTION OF THE DRAWINGS

Other objects, features, and advantages of the present invention will become apparent upon consideration of the following detailed description and the accompanying drawings, in which like reference designations represent like features throughout the figures.

FIGS. 1A to 1D show a number of perspective views of a case for a portable electronic device in accordance with an embodiment of the invention.

FIG. 2 shows a front view of the case in accordance with an embodiment of the invention.

FIG. 3 shows a back view of the case in accordance with an embodiment of the invention.

FIG. 4 shows a right side view of the case in accordance with an embodiment of the invention.

FIG. 5 shows a left side view of the case in accordance with an embodiment of the invention.

FIG. 6 shows a top side view of the case in accordance with an embodiment of the invention.

FIG. 7 shows a bottom side view of the case in accordance with an embodiment of the invention.

FIGS. 8A to 8C shows a side view of the case and the operation of an engagement mechanism in accordance with an embodiment of the invention.

### DETAILED DESCRIPTION OF THE INVENTION

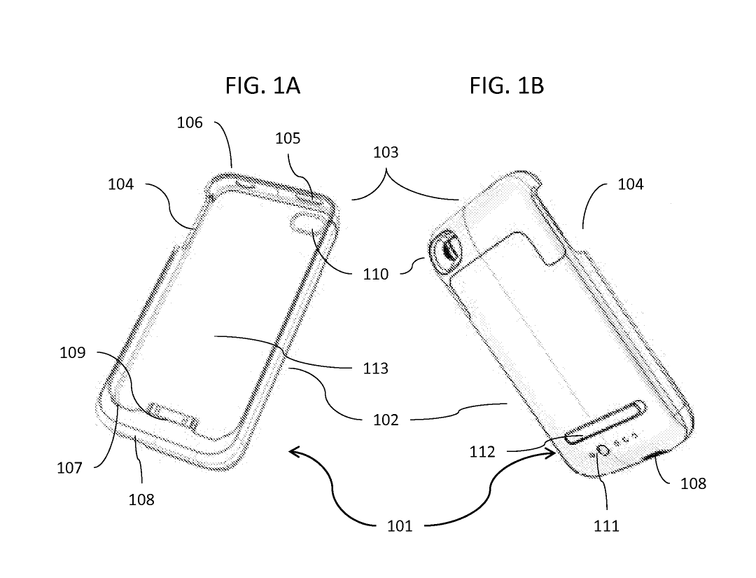

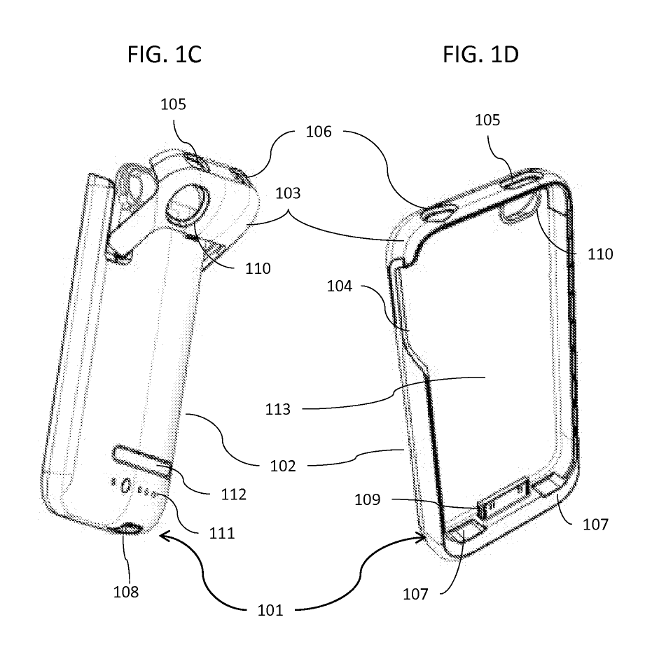

The current invention is directed to a case that protects and provides auxiliary power to a portable electronic device. FIGS. 1A-1D show an embodiment of the invention. As shown the invention generally encompasses a case (101) designed to protect a portable electronic device (e.g., smartphone, music player, or camera) from damage and also has a built-in battery to extend the battery life of the portable electronic device. FIGS. 1A-1D show a series of perspective views of the case. As shown, the case is a single piece structure having a lower portion (102) and a rotatably interconnected upper portion (103), where the case encloses a built-in battery. The lower case portion may also be referred to as a first case portion and the upper hinged case portion may be referred to as a second case portion.

The case is designed such that the portable electronic device slides into the lower case portion with the upper case portion in an open position as shown in FIG. 1C. The hinged upper case portion then swings closed over the open-portion of the lower case portion and attaches thereto, thereby enclosing and securing the portable electronic device in place as shown in FIGS. 1A, 1B or 1D. Further, as described above the case includes a battery, enclosed therein, to supplement the battery of the portable electronic device, thus increasing running time for the portable electronic device.

The case battery may be disposable or rechargeable, but is preferably a rechargeable type. In a specific embodiment, the case battery is a rechargeable lithium-ion polymer battery, however, other rechargeable battery types may be used. For example, some other rechargeable type batteries include nickel cadmium (NiCd), nickel metal hydride (NiMH), lithium ion, lithium polymer, lead acid, and other rechargeable battery chemistries. The battery may be replaceable or not replaceable. Where the battery is replaceable by the user a battery access hatch may be incorporated into the case design.

The case (101) as shown in these figures, is designed to protect the portable electronic device and has openings which allow a user to access the features of the device. For example, the top and sides of the case (shown in FIGS. 1A and 1D) may include openings for on/off or sleep/wake switches (104), volume and ring/silent controls (105), and headset jacks (106), etc.

Likewise, on a bottom side edge of the case (shown in FIGS. 1C and 1D), there may be included speaker and microphone openings (107) and an external electrical connector (108). The external electrical connector (108) is interconnected to an internal electrical connector (109), which is, in turn, designed and disposed to mate with the electrical connector on the electronic device (not shown). Via the external electrical connector, the phone can be charged or connected to another device, such as a computer or another smartphone, for synchronizing or transferring of files. The inner and outer connectors of the case can take any suitable form. In particular, the inner connector can have any number or combination of pins and shapes in order to interface with the portable electronic device that the case is designed for. Likewise, although the figures show an implementation of the case that incorporates a mini-USB connector (e.g., USB mini-B), other connectors may be used such as USB type A, type B, mini-A, micro-AB, or micro-B, FireWire, eSATA, or a proprietary connector may be used instead or in addition. Preferably, the connector chosen allows the electronic device to both be charged by a power source and data synchronized.

Finally, the back of the case may include openings for a camera lens and flash (110), as well as optional indicator lights (111) and bracket arm (112) for allowing the device to stand up in a hands free mode. The design of each of these features which will be described in greater detail in reference to the figures to follow.

As shown in FIGS. 1A and 1D, the upper and lower portions of the case define an opening (113) in the front, through which the user can view and access the screen of the device. As shown in FIG. D, the opening (113) has a closed-polygon shape. Although one shape is shown in figure, the closed-polygon can take any suitable shape, such as, for example, square, trapezoid, pentagon, hexagon, octagon, star, circle, arch, or oval. In a specific implementation, the closed-polygon shape is a rectangle with rounded corners. This closed-polygon shape is formed by the merging of two open-polygon shapes as shown in FIG. 1C. The upper hinged case portion (103) has a first open-polygon front opening; this shape may generally be described as an upside down U. The lower case (102) portion has a second open-polygon front opening; this shape may generally be described as a U. To close the case, the upper case portion (103) is rotated about a hinged access and fixed into position against the lower case portion (102) via a locking mechanism (114) as shown best in FIG. 1C, and described below. Then the upside-down U of the upper case portion joins with the U of the lower case portion to form the rectangular closed-polygon-shaped front opening shown in FIG. 1A.

In each case, the openings in the case are designed to line up with the controls and features of the electronic device enclosed therein. Accordingly, while the device is in the case (101), the user will still be able to access all the features of the device.

Although the specific embodiment of the case shown in these figures is designed with features of a standard mobile or smartphone in mind, it should be understood that features and aspects of this case may be applied to cases a wide-range of portable electronic devices and device types, such as, for example, a portable or handheld gaming device, portable or palm-sized computer, personal digital assistant (PDA), pager, audio player, video player, media player, cassette player, compact disc (CD) player, digital video disc (DVD) player, camera, video recorder, digital recorder, voice recorder, music recorder, digital audio recorder, or nonvolatile memory storage. For example, the openings, connectors, etc. may be modified such that the full functionality of these alternative devices is conserved.

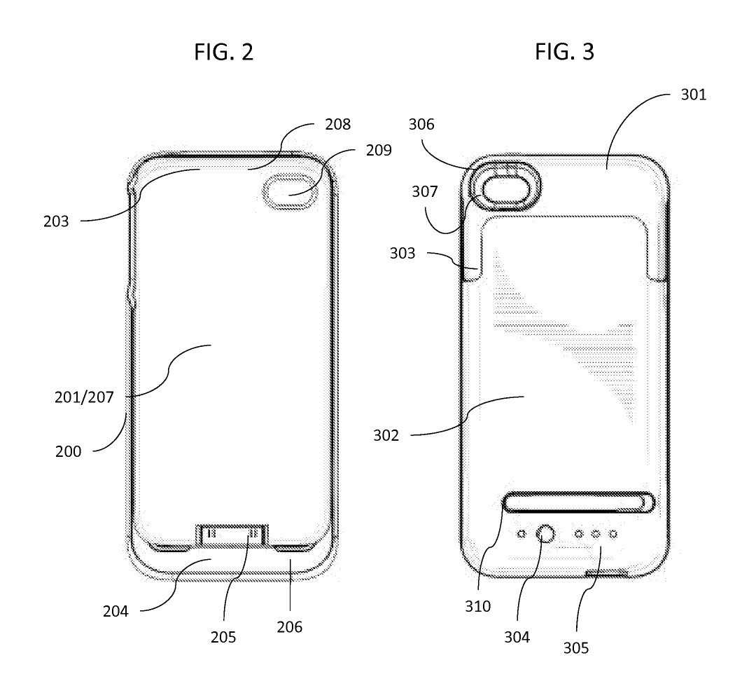

Turning now to the specific features of the case. As shown in FIG. 2, the lower case portion has retaining edges (200) that run about the periphery of the opening (201). The edges retain, protect and cushion the phone in the case. In a specific embodiment, the edges of the case form a generally flat plane. In another preferred embodiment, the frame edges raise the phone's screen from the plane of the frame edges. Also, generally, front opening (201) is smaller than the front face of the electronic device. In other words, for example, a length of the front opening is less than a length of the phone's front face. In addition, the corners of the front opening can also be rounded (or square in other implementations).

When placed in the case, a back of the electronic device will be placed against internal front surface (202). The internal surface has top (203) and a lower sidewalls (204). The lower sidewall (204) will be positioned against the bottom side edge of the electronic device. On the lower sidewall (204) is an inside or inner electrical connector (205), which is positioned and will connect to the electrical connector on the bottom side edge of the electronic device. To the left and right of the inner connector are left speaker openings and right speaker openings (206). Each of the speaker openings may include one or more individual openings. The electronic device's microphone and speakers transmit sound through these speaker (or audio) openings. A more detailed discussion of the connector and the audio openings are provided below.

Turning to the overall construction of the internal electronic device compartment (207) within the case, the internal front surface (202) generally has a contour that matches or conforms to the back of the phone or other electronic device which will lie on the internal front surface. For example, if the electronic device has a convex curved back, then the internal front surface will have a concave curved surface. The internal front surface gives good support for the electronic device. A length of the internal front surface is such that when an electronic device is placed on the internal front surface, the top edge of the internal front surface is roughly aligned (e.g., same length, slightly longer, or slightly shorter) with a top side edge of the electronic device. In addition to being contoured to properly match the electronic device, the internal front surface (202) may also incorporate other support structures, such as for example, raise vertical or horizontal strips (not shown) to provide additional shock resistance to the electronic device. These strips can be made of a material that has cushioning properties such as rubber, vinyl, polymer, plastic, foam (e.g., material with bubbles), or silicone. Depending on the material used, the strips may also be slightly tacky. These strips help cushion the electronic device and prevent it from becoming scratched or marred, especially when inserting the device into the lower case portion. The strips also help to gently grip the electronic device so that it does not inadvertently slide or become as easily dislodged from the lower case portion. It should be understood that any specific arrangement and number of strips may be used, or the strips can be omitted entirely.

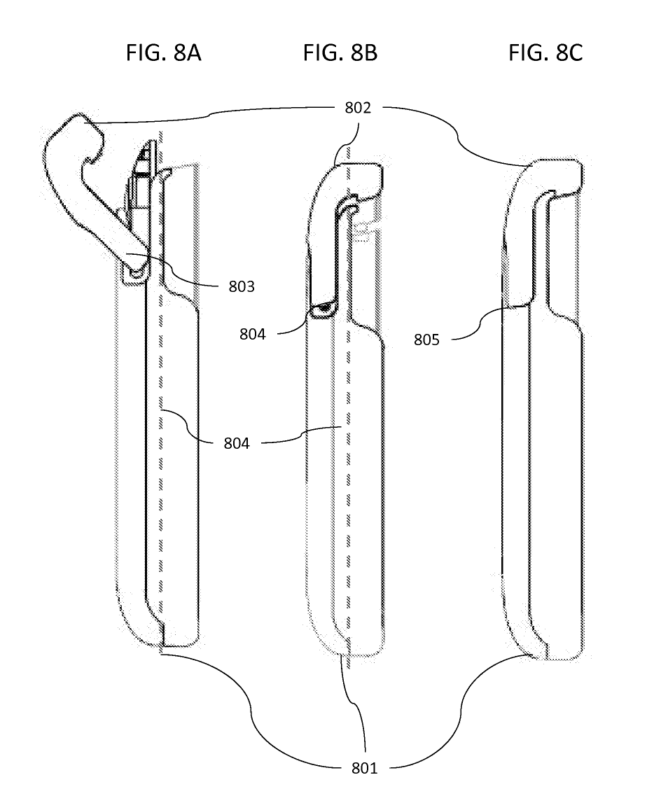

During use, the electronic device (e.g., the phone) is placed into the compartment (207) through the hinged top opening (208) and inserted (e.g., by sliding) into the compartment until the device interconnects with the inner electric connector (205) and rests against the lower surface (204) of the compartment (207). After the electronic device is placed within the case, the user closes the hinged upper portion (208) and locks said hinged upper portion into place. The operation of the hinged upper portion will be described in greater detail with reference to FIGS. 8A to 8C, below.

FIG. 3 shows a back view of the case. As shown, although the back is contoured, in a preferred embodiment a region of the back surface is provided that is relatively flat. The flat portion of the back surface ensures the electronic device and case will be stable (e.g., not rock back and forth) when the case is placed on its back on a flat surface. In the embodiment shown in FIG. 3, both the upper (301) and lower (302) case portions have adjacent sections which are flat. Where the upper and lower case portions meet, a seam line (303) divides the upper and lower case portions. In a preferred embodiment, the seam where the upper and lower case portions meet is flush, so the seam does not cause the case to be unstable. Although as shown in FIG. 3, the flat portion of the back surface is centered in back of the assembled case, it should be understood that in other implementations the flat back surface may be located anywhere on the back of the case portions. Further, the flat back surface may be of any size, any shape, any combination of sizes, or any combination of shapes. For example, the flat back surface may have a circular or oval shape. The flat region may be rectangular with rounded corners.

As shown, in one embodiment, there may be incorporated a case button (304) and indicator lights (305) (e.g., light emitting diodes (LEDs) laser diodes, light bulbs, neon bulbs, or other lighting sources). In the embodiment shown, the case button is centered in the middle of the indicator lights. In this specific arrangement. Likewise, in this specific implementation, the indicator lights are positioned horizontally on the back of the lower case portion and the indicator lights and case button have a circular shape. It should be understood that the case button and indicator lights may take any configuration (e.g., off-center or vertically arranged)., shape (e.g., square, rectangle, triangle, and oval), or number of (e.g., one, two, three, or four or more). These indicator lights are optional and may function as any desired status indicator. For example, the indicator lights may function when entering the power-up mode, the indicator lights may function to indicate to the user that the case has been powered up, or the indicator lights may function to indicate the current level of battery life remaining. In turn, the lights may be activated in any suitable manner. For example, power-up may be indicated to the user using any visual. (or audible) indication. In a specific implementation, for example, one of the LEDs turns on for a short time and then turns off. In another implementation, each of the LEDs may turn on and off in sequence. In another implementation, at least one LED turns on and stays on while the case is connected to a charging source. In this implementation, the number of lights turned on is proportional to the battery life and the number of lights increases as the battery life increases

In the embodiment shown, both the upper and lower case portions include a camera opening (306) (see also FIGS. 1C and 2). Once the upper portion (301) has been locked into place, the upper case portion's camera opening aligns with the lower case portion's camera opening to form a single camera opening (306) extending through the body of the case. Through this opening the camera lens of the electronic device will have an unobstructed view through the camera openings of the lower and upper case portions.

As shown in FIGS. 2 and 3, in one embodiment, the camera opening (306) expands from the opening (209) in the lower portion of the case to the inner opening (307) of the upper portion of the case, and continues to expand to the outer opening (306) of the upper portion of the case. In other words, the camera opening (307) is smaller (i.e., smaller diameter) than camera opening (306). Note that if the lower portion of the case is sufficiently shorter than the electronic device, camera opening (307) may be omitted or partially omitted from the lower case portion. This outwardly conical or frustoconical expanding camera opening arrangement, allows for a greater field of view for the camera than would be possible with a simple opening. Although any suitable conically expanding opening may be used, in one exemplary embodiment the lens hood has about a 31 degree field of view. In other implementations, however, the field of view can be any desired number of degrees, less than or greater than 31 degrees. The angle of view provided by the case will depend on the field of view of the camera of the phone and will generally be at least as wide as the camera's field of view, so that the lens hood will not appear in the photos taken by the camera.

Although in a specific embodiment, the camera openings are circular, in other implementations, the camera openings can be any shape or closed polygon (e.g., such as a triangle, square, rectangle, trapezoid, or other. Generally, the openings will have a similar shape and openings closer to the camera lens will be smaller than those further away. In addition, although a simple camera opening is shown in FIGS. 2 and 3, it should be understood that a transparent lens covering may be incorporated into one or more of the camera openings (209 to 306 to 307), thereby further protecting the lens from scratching or damage.

As also shown in FIG. 3, the case may incorporate an optional bracket arm (310) that can be hingedly rotated out from the back of the case. This bracket arm can be used as a stand to prop the case and enclosed electronic device up at a fixed angle, thereby allowing for the hands free viewing and operation of the enclosed electronic device. Although the bracket arm (310) is shown as being of rectangular shape and as being positioned in the lower half of the case just above the indicator lights (305), it should be understood that the bracket arm may take any suitable cross-section, length and shape, and be disposed along any portion of the case such that it can extend and serve to prop the electronic device up in a standing position in one of either a portrait or landscape viewing mode.

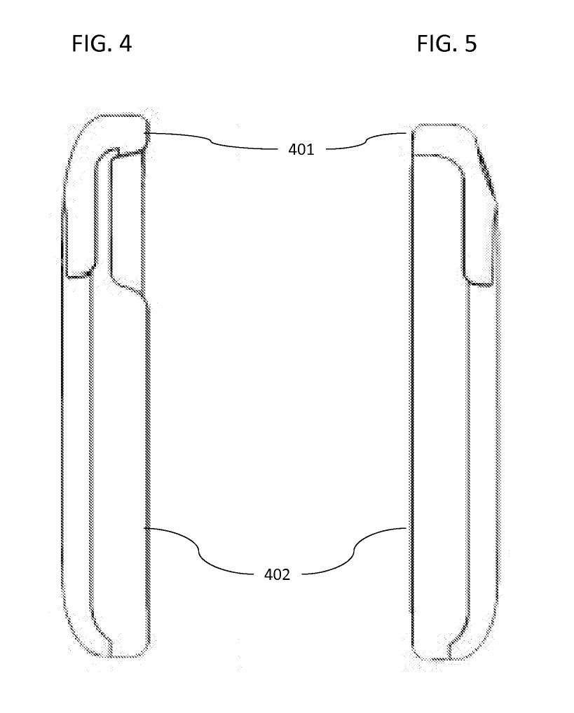

FIGS. 4 and 5 show right and left side views of the assembled case, respectively. As shown, where the upper (401) and lower (402) case portions meet, there is a seam line that extends across the back and through the sides of the case to the front. It should be understood that the specific design and shape of the interconnection between the upper and lower case portions is not critical to the design of the case as long as the upper case portion is designed to hingedly rotate away from the lower case portion sufficiently to allow for the electronic device to be inserted within the lower case portion. The operation of the hinged interconnection between the upper and lower case portions will be discussed in more detail with regard to FIGS. 8A to 8C, below.

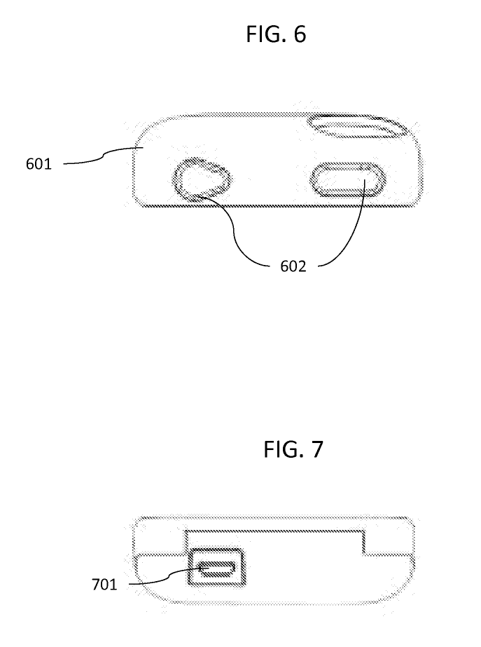

FIG. 6 shows a top view of the upper case portion. As described above, the upper case portion (601) may include a number of openings (602) to allow the user access to the buttons, switches and jacks on the enclosed electronic device. Although a certain number of such openings is shown in this embodiment, it should be understood that any number and configurations of openings necessary to preserve the underlying functionality of the electronic device may be provided.

FIG. 7 shows a bottom side view of the lower case portion. The lower case portion has an outside or outer connector (701) (e.g., a mini-B USB connector) and a grille or outside speaker openings (not shown) that are positioned on an outside bottom side. The outer connector allows a user to connect the case and device via a cable (e.g., USB cable) to a power source or to synchronize with another electronic device. In the specific implementation in FIG. 7, the outer connector is positioned at a bottom side edge of the lower case portion (or portion which encloses or conceals the battery). However, in other implementations, the outer connector may be positioned at any other suitable location, including on the upper case portion.

The outside speaker opening allows sound output (e.g., stereo sound output) from the electronic device to travel through speaker openings and then out of the case through the further openings therein (not shown). The openings are, therefore, preferably aligned with the speaker outputs on the electronic device. Note that although the openings shown in the embodiments herein are made up of individual circular openings, there can be any number of openings, larger or smaller than the openings shown, and each opening may have a different shape.

Turning now to FIGS. 8A to 8C and the operation of the hinged upper portion and the locking engagement of the case. Like a sleeve, the electronic device is slid into the lower case portion (801) until being stopped by the lower inner surface of the lower case portion. When the electronic device is fully inserted within the lower case portion, the hinged upper portion (802) is rotated about its hinged interconnection (803) with the lower case portion until the upper portion is aligned with the axis (804) of the lower portion.

Once the upper and lower portions are aligned, the upper portion is move axially downward toward the lower portion such that the hinged interconnection armature (803) moves into the interconnecting groove (805) thereby locking the upper portion into place over the electronic device and against the lower portion of the case. Where the upper and lower case portions meet, the exterior surfaces become flush with each other. When the upper case portion is seated against the lower case portion, on a back side of the case, the upper case portion overlaps at least one portion of the lower case portion to hold the upper case to the lower case portion. It should be understood that the upper and lower portions may be held together via any suitable interconnecting means. For example, the upper case portion may hold onto the left and right inserts of the lower case portion through friction, or via a compression fitting, latch, snap, alignment tab, etc. Regardless of the specific locking mechanism, the upper case portion securely engages the lower case portion, so the upper case portion will not inadvertently slide away form and rotate out of alignment with the lower case portion.

FIGS. 2, 3, and 8A to 8C collectively show all angles of the interconnection between the upper and lower portions of the case. As described above, the upper case portion rotates into alignment with and then slidingly engages the lower case portion. Where the upper and lower case portions meet, there are seam lines (806) (in the front of the case see also FIG. 2 and for the back of the case see also FIG. 3). The seam line runs around the entire case (e.g., across the back of the case). At the seam, the surfaces of the lower and upper case portions are relatively flush with each other. The seam line remains visible and can be fell tactilely. Although the seam line is shown running about approximately the upper third of the case, it should be understood that in other implementations the seam lines can be at other positions. For example, the seam line can be aligned with an upper edge of electronic device, or anywhere between the upper and lower edges of the electronic device.

Turning now to the operation of the case. Although not shown clearly in all figures, it should be understood that the case includes a number of essential. electronic features, including an inner connector, a case battery, and an outer connector. Optionally, the case may also include a battery status indicator, a synchronization indicator and a user input element. Regardless of the specific features the case will also include internal circuitry, memory and logic sufficient to allow for the operation of these features, and their interconnection with a specified electronic device.

In relation to this circuitry, the case has numerous modes of operation, including:
An auxiliary battery power-up mode during which the case itself is charged. To enter this mode, the phone does not need to be in the case; but if the phone is in the case, the circuitry should be designed such that the user will be able to use the phone normally. If the optional indicator lights (e.g., LEDs) are present, these lights may be lit to show the charging status of the case. Or, alternatively, the user can press the case button and determine the battery life remaining in the case battery by reading the indicator lights. In this mode, the power source may be a power socket, power receptacle, or power outlet in the user's home or office. Alternatively, the cable can be connected to a computer's USB port or any other power source. Circuitry in the case is designed to control charging of the battery until it is fully charged.
A primary battery power-up mode during which the electronic device may be charged. While charging the case battery in the charge auxiliary battery mode, the electronic device does not need to be in the case, however, if the electronic device is in the case, the case will also be in the charge primary battery mode. When the electronic device battery becomes discharged, the case battery will, via the inner connector, charge and top off the electronic device's battery as needed. The case will continue to charge the electronic device battery as needed until the auxiliary case battery becomes completely discharged. If the outer connector is not connected to power, the case can be in the charge electronic device battery mode as long as there is charge in the case battery, but the case will no longer be in the charge auxiliary battery mode.
A sleep mode where the case stops charging the electronic device. If the case is not connected to a power source and the case battery is at a charge level below a certain threshold, the case will enter a sleep mode where the case becomes inactive (e.g., the case button and case indicator lights, where present, are not functional). In such a mode, the case will be designed so that it does not draw any power from the electronic device. When the user connects a power source via a cable (e.g., USB cable) to the case's outer connector, the case will immediately charge the electronic device battery and the case battery. Both the phone and case batteries will be charged in parallel even if the case battery does not have a minimum level of charge.

Although three primary modes are described above, other modes of operation may be present, such as, for example, an extended sleep mode, where the circuitry of the case will use less power so the case will retain its battery power for relatively longer periods of time.

In addition, the circuitry of the case may incorporate other logic functions, such as, for example, authentication circuitry, which allows the case to communicate with the phone, either through a handshaking protocol or certificates. If such circuitry is present, then the phone will operate with the case, whereas, if the phone does not authenticate the case, it cannot be presented as a valid accessory and the phone screen displays a warning message.

It should also be understood that the interconnections and circuitry can be designed to allow the user to synchronize the phone with a second electronic device via the electronic connector. In such an embodiment, when the case is connected to a computer via a cable (e.g., USB cable), the user can synchronize data between the phone and the computer, send data from the phone to the computer, send data from the computer to the phone, or any combination of these.

Turning to the construction of the case itself, it should be understood that the case may be made of any suitable material., such as, for example, a hard or rigid plastic or a nonelastomeric material such as a polycarbonate (e.g., Bayer PC2405 or Makrolon® by Bayer Material. Science LLC). The case material can be a plastic such as a high density polyethylene, low density polyethylene, thermoplastic, amorphous thermoplastic, or other resin or polymer. Some examples of suitable thermoplastics includes acrylonitrile butadiene styrene (ABS), acrylic, celluloid, cellulose acetate, ethylene-vinyl acetate (EVA), ethylene vinyl alcohol (EVOH), fluoroplastics, ionomers, Kydex®, liquid crystal polymer (LCP), polyacetal (POM or acetal), polyacrylates (acrylic), polyacrylonitrile (PAN or acrylonitrile), polyamide (PA or nylon), polyamide-imide (PAI), polyaryletherketone (PAEK or ketone), polybutadiene (PBD), polybutylene (PB), polybutylene terephthalate (PBT), polycaprolactone (PCL), polychlorotrifluoroethylene (PCTFE), polyethylene terephthalate (PET), polycyclohexylene dimethylene terephthalate (PCT), polyhydroxyalkanoates (PHAs), polyketone (PK), polyester, polyethylene (PE), polyetheretherketone (PEEK), polyetherketoneketone (PEKK), polyetherimide (PEI), polyethersulfone (PES), polysulfone, polyethylenechlorinates (PEC), polyimide (PI), polylactic acid (PLA), polymethylpentene (PMP), polyphenylene oxide (PPO), polyphenylene sulfide (PPS), polyphthalamide (PPA), polypropylene (PP), polystyrene (PS), polysulfone (PSU), polytrimethylene terephthalate (PTT), polyurethane (PU), polyvinyl acetate (PVA), polyvinyl chloride (PVC), polyvinylidene chloride (PVDC), and styrene-acrylonitrile (SAN).

A soft-touch or rubberized coating may be applied to the case surface to help improve a user's grip on the case. The soft-touch coating can make the case surface tacky or slightly tacky. In an implementation, both upper and lower case portions are made from the same material. However, in other implementations, the upper and lower case portions may be made of different types of materials (e.g., different types of plastics). In other implementations, the case material may be (or include), rather than a hard or rigid plastic, a compliant or rubber-like material such as a gel., elastomeric, silicone, or rubber.

When a hard plastic is used, some portions of the case can be polished to have a high gloss finish (e.g., similar to a glossy black piano), while other portions will have the soft-touch coating (which is a matte finish). In other implementations, all surfaces can have a high gloss finish. Or, all surfaces can be coated with the soft-touch coating.

The high gloss finish can be obtained or achieved by polishing, sanding, rubbing, or buffing the surface with a relatively fine grit material. (e.g., sandpaper, polishing cloth, or paste). One can polish the plastic with successively finer grit materials until the desired finish is obtained. Polishing can be performed using a buffing machine, such as a rotary buffing machine or other buffing machine.

In other implementations, the case can be a material other than plastic. Some examples of case materials include metal (e.g., stainless steel or titanium), glass, transparent or translucent plastic, sapphire, diamond, leather, vinyl, quartz, granite, and many others.

This description of the invention has been presented for the purposes of illustration and description. It is not intended to be exhaustive or to limit the invention to the precise form described, and many modifications and variations are possible in light of the teaching above. The embodiments were chosen and described in order to best explain the principles of the invention and its practical applications. This description will enable others skilled in the art to best utilize and practice the invention in various embodiments and with various modifications as are suited to a particular use. The scope of the invention is defined by the following claims.

What is claimed is:

1. A case for an electronic device comprising:
a lower case portion comprising:
an electronic device compartment for containing the electronic device, said compartment being defined by a back surface and bounded by left, right and lower sidewalls, and a top edge, wherein the back side of the electronic device rests against the back surface of said compartment and the lower side of the electronic device rests against the lower sidewall,
a battery, enclosed in the lower case portion,
electronic circuitry, coupled to the battery for controlling the function of said battery,
a inner electric connecter disposed on the inner surface of the lower sidewall and positioned to interconnect with a electric connector on the electronic device, said inner electric connector being electrically coupled through the electronic circuitry to said battery, and
an external electric connector electrically coupled through the electronic circuitry to said battery and said inner electric connector; and
an upper case portion rotatably and slidingly interconnected with said lower case portion, said upper case portion comprising:
left, right and upper sidewalls, wherein the upper sidewall is positioned against a top side edge of the electronic device when the upper case portion is seated against the lower case portion, and
an open side end, opposite of the upper sidewall; and
wherein the upper case portion rotates about the top edge of said lower case portion until said upper case portion is axially aligned with said lower case portion, and then slides axially in a direction from the top edge to the lower sidewall of the lower case portion until said upper case portion is seated against the lower case portion to enclose the electronic device therebetween; and
wherein the upper and lower case portions both comprise front openings that when merged form a combined front opening through which a screen of the electronic device is visible.

2. The case of claim 1 wherein the sidewalls of one of either the upper or lower case portions further comprise at least one opening through which functional portions of the electronic device will be accessible.

3. The case of claim 1 wherein one of either the lower or upper case portions further comprise at least one user control coupled to the electronic circuitry, and designed to activate at least one function of the case.

4. The case of claim 1, wherein one of either the lower or upper case portions further comprise at least one indicator coupled to the electronic circuitry, said at least one indicator being designed to indicate the status of at least one aspect of the function of one of either the case or the electronic device.

5. The case of claim 4, at least one indicator specifies a level of charge remaining for the battery.

6. The case of claim 1, wherein at least one of the upper and lower case portions further comprise an opening against which a camera lens opening of the electronic device will be placed.

7. The case of claim 1, wherein the lower case portion further comprises at least one opening positioned on the lower sidewall, such that when the electronic device is inserted into the compartment the speaker outputs of said electronic device are aligned with said at least one opening in said lower sidewall.

8. The case of claim 1, wherein the lower and upper case portions are formed of a rigid plastic material.

9. The case of claim 1, wherein the front opening of the lower portion comprises a U shape, and the front opening of the upper portion comprises an upside-down U shape.

10. The case of claim 1, wherein when the upper case portion is seated against the lower case portion, the upper case portion overlaps at least one portion of the lower case portion.

11. The case of claim 1, wherein when connecting a cable to the outer connector of the lower case portion, the cable does not pass through any opening of the case.

12. The case of claim 1, wherein the lower case portion further comprises an extendable bracket armature attached to the back thereof, said bracket armature being designed to support the case in a standing position.

13. The case of claim 1, wherein the upper portion lockingly engages the lower portion via an engagement mechanism.

14. The case of claim 14, wherein the engagement mechanism is selected from the group consisting of friction fittings, compression fittings, snaps, and latches.

15. The case of claim 14, wherein the upper portion rotates about a hinge, and wherein the engagement mechanism is incorporated into said hinge.

16. The case of claim 1, wherein the external connector is a mini-USB connector.

17. The case of claim 1, wherein the battery is a rechargeable battery.

18. The case of claim 1, wherein the electronic device is a smartphone.
